(19) United States
(12) Patent Application Publication
(10) Pub. No.: US 2008/0221924 A1
(43) Pub. Date: Sep. 11, 2008

(54) APPARATUS, SYSTEM, AND METHOD TO IMPROVE THE ACCURACY OF RADIO FREQUENCY IDENTIFICATION (RFID)-BASED REAL-TIME LOCATION SYSTEM

(75) Inventor: Hakan Mehmet Ilkin, Pittsburgh, PA (US)

Correspondence Address: K&L GATES LLP, 535 SMITHFIELD STREET, PITTSBURGH, PA, 15222, US

(73) Assignee: ENTELECHY HEALTH SYSTEMS L.L.C. C/O PERIOPTIMUM, Pittsburgh, PA (US)

(21) Appl. No.: 12/045,581

(22) Filed: Mar. 10, 2008

Related U.S. Application Data
(60) Provisional application No. 60/906,087, filed on Mar. 9, 2007.

(51) Int. Cl. G06Q 10/00; G08B 1/08

(52) U.S. Cl. 705/2; 340/539.13

(57) ABSTRACT

A patient workflow management system. The system includes a messaging subsystem to receive data indicating one or more locations of a patient within a health care facility. The system further includes a correction module in communication with the messaging subsystem to apply a correction to at least a portion of the received data to determine a location of the patient relative to a perioperative workflow process.

### PRIORITY CLAIM

The present application claims priority to U.S. Provisional Patent Application Ser. No. 60/906,087, filed Mar. 9, 2007, which is incorporated herein by reference.

### BACKGROUND

As the patient advances through the workflow process, there is a need to track the progress of the patient. Tracking the progress of the patient, however, may be difficult for the hospital staff. Staff members must monitor the patient using a combination of verbal communications via telephone calls and in-person conversations, and personal observations. However, it may be difficult for health care facility staff to obtain that information. Consequently, the staff can become embroiled in the task of chasing down information concerning the patient progress, causing delays in communication, which can translate directly to delays in patient care. This also may result in neglect of other duties.

In addition, the staff also must contend with the manner in which changes in patient treatment schedules affect the workflow process. Should there be a deviation from or change in the workflow process schedule of any patient, the staff must be made aware of such changes in order to alter their activities accordingly. In such instances, the staff members are faced with the similar information-gathering difficulties as previously discussed. These difficulties can result in the staff falling further behind schedule and cause further delays in patient care.

The location (e.g., position) information of patients and resources within a health care facility may be tracked with a Real-Time Location System (RTLS) based on radio frequency identification (RFID) technology. Conventional RTLS based on RFID technology, however, may yield erroneous or improper patient location information. Although some form of logic may be added to a conventional RTLS to reduce these errors, they still may occur with fairly high frequency. In some circumstances, for example, the error rate may be as high as 50%. Thus, there may be a need for improved techniques to reduce or minimize errors in location information of a patient within a workflow process in a health care facility. More particularly, there may be a need for improved techniques to reduce or minimize errors in location information of a patient within a workflow process in a health care facility produced by conventional RTLS based on RFID technology.

### SUMMARY

In one general respect, the present application is directed to a patient workflow management system. The system includes a messaging subsystem to receive data indicating one or more locations of a patient within a health care facility. The system further includes a correction module in communication with the messaging subsystem to apply a correction to at least a portion of the received data to determine a location of the patient relative to a perioperative workflow process.

### BRIEF DESCRIPTION OF THE DRAWINGS

FIG. 1 illustrates one embodiment of a patient workflow process system comprising a patient workflow management (PWM) system.

FIG. 2 illustrates one embodiment of a PWM system.

FIG. 3 is a diagram of one embodiment of a correction module to improve the accuracy of a real-time location system based of radio frequency identification technology.

FIG. 4A is a diagram illustrating the stages of one embodiment of a perioperative workflow process for an ambulatory patient.

FIG. 4B is a diagram illustrating the stages of one embodiment of a perioperative workflow process for an inpatient.

### DESCRIPTION

The various embodiments described herein are directed generally to apparatuses, systems, and methods for distributing information associated with a patient workflow process in a health care facility. As previously discussed, a workflow process includes the systematic process of a patient moving to different locations or departments within the health care facility to receive medical treatment, including, for example, a perioperative process. As previously discussed, a health care facility includes any hospital, clinic, stand-alone surgery center, or any medical facility that provides medical diagnostic and/or therapeutic treatment services. A health care facility may comprise multiple diagnostic and/or therapeutic departments, such as radiology, oncology, catheterization, emergency, and/or surgical departments located throughout the health care facility. There is a need to track the progress of a patient through the workflow process in any of these departments. To determine or track the progress of the patient in the workflow process, the location information needs to be known with suitable accuracy. Accordingly, various embodiments of a tracking system described herein are directed to tracking and/or distributing information associated with the progress of a patient advancing through a workflow process. For example, during a perioperative workflow process, the location of a patient may be tracked during the preoperative, intraoperative, and postoperative phases of surgery. Thus, to determine or track the progress of the patient through the perioperative workflow process, the location of the patient should be tracked with suitable accuracy.

In addition, various embodiments described herein are directed to apparatuses, systems, and methods for distributing messages concerning the progress of a patient through a patient workflow process to people having an association with, interest in, caring for, or relationship with the patient. Patient progress information may comprise physical or logical location or position information associated with the patient in any workflow process in the health care facility. For convenience and clarity, any person associated with, interested in, caring for, or having a relationship with the patient may be referred to herein as a “stakeholder.” For example, the term stakeholder may refer to the patient family members and/or the hospital staff. It is to be understood, however, that as used herein, the term “family” is intended to encompass more than just the traditional family members of the patient and comprises friends, relatives, guardians or any person designated by the patient or legal authority as having an association with, any interest in, or any relationship with the patient. Furthermore, as used herein, the term “staff” refers to doctors, surgeons, anesthesiologists, nurses, and any other person responsible at some level for providing patient care. The embodiments, however, are not limited in this context.

When the patient progress information associated with a perioperative process is received by a managing computer system, the information may be distributed to the health care facility staff and the patient family members as described in various embodiments herein. In accordance with these embodiments, information associated with the state of the patient progress through the perioperative process is collected and processed. Such data can be collected through one or more methods. For example, the data may be entered manually through a workstation coupled to a computer system by a local area network. In addition, the data also may be entered automatically into the system by one or more techniques, such as reading the location of a patient from a patient locator badge and a RTLS. In one embodiment, a RTLS may comprise RFID technology wherein the patient is provided with an RFID tag that can be read and monitored by an RFID-tracking system, for example. The embodiments, however, are not limited in this context.

A computer system may be implemented as a server to receive the patient workflow process information or data from any source. The computer system may have knowledge of a proposed course of diagnostic and/or therapeutic treatment for the patient in any department of the health care facility, as well as the steps and processes which are implicated by that course of treatment. The computer system may comprise a component or module that determines the accuracy of incoming RTLS patient location information.

A process in accordance with various embodiments may comprise one or more computer systems receiving user input through a graphical user interface (GUI). This user interface may be a program which is executed on a workstation coupled to the computer system through a network, such as, for example, a local area network (LAN), available to the staff and/or the family members. The user interface may be configured to receive data from either the staff or the family members which the system will use to determine which events during the patient workflow process may trigger a correction to the RTLS information.

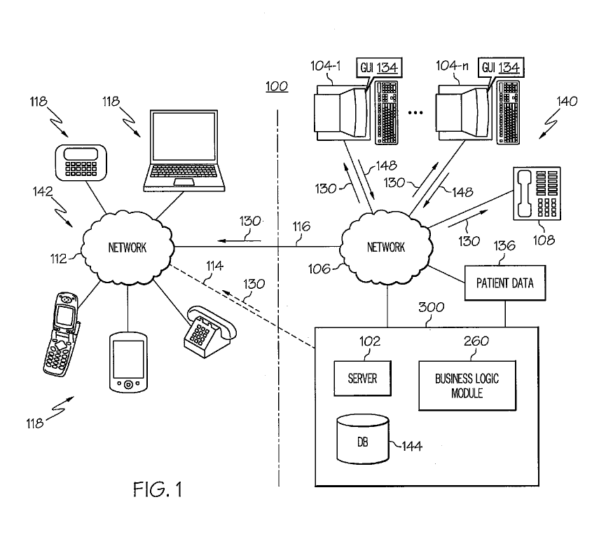

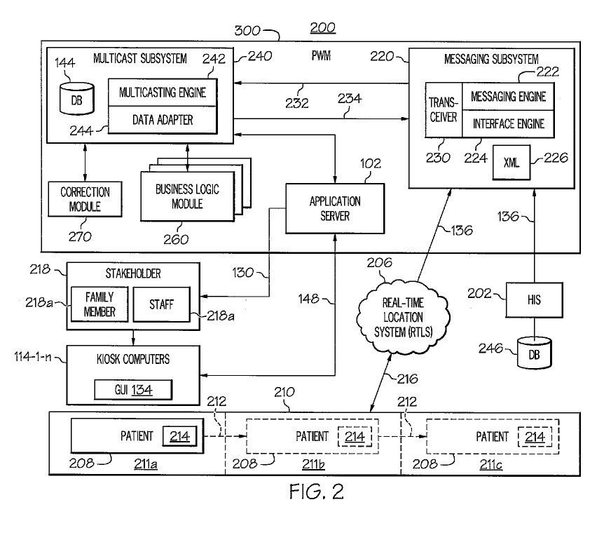

FIG. 1 illustrates one embodiment of a patient workflow management (PWM) 300 within the context of a health care facility communication infrastructure. The PWM system 300 may be adapted and configured to receive patient workflow process information or data 136 (“patient information” hereinafter) from a variety of sources. The patient information 136 may be received from a hospital information system 202 (HIS) (FIG. 2), a real-time location system 206 (RTLS) (FIG. 2), which could be a RFID tracking system, for example. In one implementation, the patient information 136 may be provided substantially on a real-time basis and may be stored in a database 144. In general, the patient information 136 comprises the state of the patient through the patient workflow process. As previously discussed, the patient workflow process refers to the progress of a patient in any health care facility diagnostic and/or therapeutic process in any one of a radiology, oncology, catheterization, emergency, and/or surgical department. The patient information 136 refers to any information associated with any of these processes. During a workflow process, a patient may be transferred through any one or more of these departments to receive medical diagnostic and/or therapeutic treatments in the health care facility. In one embodiment, the content of the patient information 136 may be configurable. For example, the content of the patient information 136 may be configured to include/exclude: (1) Patient Name; (2) Care Provider; (3) Patient Location; (4) Health care Facility Site; (5) Location Group; (6) Case Information; (7) Clinical Information; (8) Event Information; and/or (9) Event Time. The patient information 136 may comprise the status of the patient, the condition of the patient, and/or the progress of the patient through the workflow process (described in more detail below in the context of a perioperative workflow). In one embodiment, the patient information 136 also may comprise the badge identification number, sensor or tag identification number, time, and type of movement.

The PWM system 300 comprises an application server 102 coupled to one or more computers 104-1-n, where n is any positive integer. The computers 104-1-n may comprise special single function computers, workstations, large screen displays, and kiosks, for example, and any other communication devices and/or media. The computers 104-1-n may comprise a display device, such as a liquid crystal display (LCD), plasma, thin film transistor (TFT), or cathode ray tube (CRT) monitor, a device for user input, such as a keyboard or mouse, a processor, an application component, and memory for receiving and processing entered information. The computers 104-1-n may be implemented as kiosks and may be made available to patient family members at various locations throughout a health care facility.

The PWM system 300 may be coupled to the computers 104-1-n over a first network 106. The first network 106 may be internal to the health care facility, such as a local area network (LAN), PBX system, and the like. The network 106 also may comprise internal network, such as the HIS 202 and the RTLS 206 shown in FIG. 2. The PWM system 300 also may be coupled to a telephone system 108 either directly or via the first network 106. The PWM system 300 may include components, such as business logic module 260, to increase the accuracy of the RTLS 206.

The PWM system 300 may be coupled to a second network 112 by way of a first connection 114. The PWM system 300 also may be coupled to the second network 112 by way of the first network 106 over a second connection 116, for example. The PWM system 300 can support virtually any computer or telecommunication mechanisms for communication. In one embodiment, the PWM system 300 may be implemented to use communication mechanisms that may be currently common within health care facility and consumer domains. Accordingly, the second network 112 may provide the PWM system 300 with access to a variety of communications devices 118. The communications devices 118 may comprise, for example, a laptop or other computer, a pager, a cell phone or smart phone, a personal digital assistant (PDA), or a landline telephone. Although the first and second networks 108, 112, respectively, are shown as separate networks, those skilled in the art will appreciate that the networks 108, 112 may be combined as a single network or may be expanded to multiple networks without limitation.

The PWM 300 tracks patients, resources, or entities located in a health care facility. The patients, resources, or entities may be located in an operating room (OR), stand-alone surgical center, oncology, radiology, catheterization, emergency, and/or a surgical department, among other departments of the health care facility. The PWM 300 tracks and stores information of specific, predetermined milestones associated with the patient progress through the workflow process. Software modules executed by the application server 102 may be configured to store the real-time patient information 136 about the status of the patient in the database 144 and to generate the messages 130 in accordance with the patient information 136. Based on the predetermined milestones (e.g., surgery begins, patient enters postoperative room, patient gets discharged may be considered milestones in a perioperative workflow process, among others), the system progresses the patient through the perioperative process.

The PWM system 300 knows the intended diagnostic and/or therapeutic treatment flow of a patient through the patient workflow process and the location of patient within that process. For the purposes of the following description, this knowledge may be assumed to be known or may be obtained by the PWM system 300 on a real-time basis. The PWM system 300 employs an active form of communication to make this information available. In one embodiment, the PWM system 300 enables the active form of communication by formatting the message 130 for the distributed information and allowing the family members to be alerted or receive the message 130 “on-demand.”

The PWM system 300 may be integrated or operate in conjunction with other systems for tracking patients throughout the patient workflow process, including communicating with external systems 142, communicating real-time data within internal systems 140, and incorporating a repository of events that are structured around a configurable set of predictive criteria (variables). Herein, the term internal systems 140 is used to refer to communication and processing systems that may pertain to a health care facility regardless of whether these systems are present in the same location. The term external systems 142 is used to refer to communication and processing systems that are not specific to the health care facility even if they may be located or accessible within the health care facility.

FIG. 2 illustrates one embodiment of a perioperative system 200. The perioperative system 200 may be associated with the surgical process in a surgical department of a health care facility. The perioperative system 200 may comprise one embodiment of the patient workflow process PWM 300 illustrated in FIG. 1 that is directed specifically to the perioperative process, although the embodiments are not limited in this context. In the illustrated embodiment, the perioperative system 200 is integrated with the PWM system 300, the HIS 202, and the RTLS 206. Although the perioperative system 200 is described as comprising one embodiment of a correction module to correct RTLS information in a perioperative workflow process, other embodiments of the perioperative system 200 may be implemented for any patient workflow processes associated with any health care facility diagnostic and/or therapeutic process in a radiology, oncology, catheterization, and/or emergency department.

In one embodiment, the RTLS 206 may be employed to track a patient 208 throughout a perioperative workflow process 210 using RTLS tags 214 located on the patient 208 or in proximity to the patient 208, or a locator badge dispensed to the patient 208 at check-in time. In one embodiment, the locator badge also may comprise the RTLS tags 214. The RTLS tags 214 and the locator badge may operatively interact with the RTLS 206. Herein, tracking the patient 208 throughout the perioperative workflow process 210 may include tracking the patient 208 through a preoperative workflow process 211a, an intraoperative workflow process 211b, and/or a postoperative workflow process 211c. The RTLS 206 captures real-time patient location data 216 and provides that data to the PWM system 300 to determine when the patient 208 transitions 212 from one location to another or from one process to another (211a→211b→211c). The location data 216 is associated with events to determine the location of the patient 208 in the perioperative workflow process 210 (or anesthesia pathways). Consequently, the gathered real-time location data 216 is provided to the PWM system 300 in the form of the patient information 136, which may be received by the PWM system 300 from the HIS 202 and/or the RTLS 206. As previously discussed, the location data 216, and, thus, the patient information 136, may include errors as to the exact location of the patient 208 in the perioperative workflow process 210 at any given time.

The PWM system 300 sends messages 130 to the stakeholders 218 based on the patient information 136 and the notification configuration message 148 submitted to the PWM system 300 by the stakeholders 218 (e.g., patient family members 218a and health care facility staff 218b). Herein, the patient family member stakeholders are referred to as family members 218a and the health care facility staff stakeholders are referred to as staff 218b. As previously discussed, the stakeholders 218 may receive the messages 130 in accordance with preferences they entered in the computers 104-1-n via the notification GUI 134. In a similar manner, the stakeholders 218 also may select the content of the messages 130, among other predetermined criteria via the notification GUI 134. In one embodiment, the PWM system 300 provides real-time visualization capabilities for the OR managers to make timely decisions regarding resource usage across multiple facilities.

The PWM system 300 receives and processes the real-time patient location data 216 received from RTLS 206 tags 214 dispensed to the individual patients 208 in the form of patient information 136. By processing the real-time patient information 136 comprising the location data 216 received from the RTLS tags 214, the PWM system 300 can determine when the patient 208 transitions 212 from one location to another within the health care facility during the perioperative workflow process 210. The real-time location data 216 from the RTLS 206 comprises information related the transitions 212 or movements of the patient 208 from one location to another during any phase of the perioperative workflow process 210 within a health care facility. The PWM system 300 may subsequently associate the real-time location data 216 with information related to the intended perioperative treatment for the patient 208 to determine the location of the patient 208 in the perioperative workflow process 210. This information may be stored and processed by the PWM system 300 after any necessary corrections are applied to the location data 216 or patient information 136. The PWM system 300 then transmits the messages 130 to the stakeholders 218 concerning the status and/or progress of the patient 208 in the perioperative workflow 210 process.

When the patient 208 workflow process information 136 (e.g., patient data) is received by the PWM system 300, the information 136 may be distributed to the stakeholders 218, e.g., the patient family 218a and/or the staff 218b members, after any necessary corrections are applied to the information 136 as described in various embodiments herein. In accordance with these embodiments, the location data 216 associated with the patient 208 progress through the workflow process 210 may be collected and processed by a RTLS 206. This information can be collected through one or more methods. For example, the information may be entered manually into the PWM system 300 through a workstation coupled to a computer system by a local area network. In addition, the information may be entered automatically into the PWM system 300 by one or more techniques, including reading the location of the patient 208 from the patient locator badge 214 or determining the location of the patient 208 with the RTLS 206. One such real-time location system may comprise RFID technology. In an RFID-based RTLS 206 environment, the patient 208 is provided with an RFID tag 214 that can be read and monitored by the RTLS 206. The embodiments, however, are not limited in this context.

In one embodiment, a patient tracking system such as the PWM system 300 may comprise a RTLS 206 based on RFID technology and one or more correction modules to improve the accuracy of the patient location data 216 in accordance with the techniques described herein. The RTLS 206 based on RFID technology may be employed for tracking persons such as the patients 208 as well as the staff, and/or any other resources or entities within the health care facility. In one embodiment, the PWM system 300 may comprise a correction module 270 to reduce errors in the location information produced by or associated with the RTLS 206. Thus, the patient 208 location data 216 or any information associated with a resource or other health care facility entities may be determined with far greater accuracy than with the RTLS 206 alone.

When the patient 208 arrives at a health care facility for a procedure, the procedure time is either scheduled before the arrival or, in emergency cases, upon the arrival. When the patient 208 is scheduled for the procedure, information about the patient 208, the care provider, and the procedure are determined by the staff 218b. This patient information, along with the proposed start time and duration of the scheduled procedure, are entered into a patient data database 246. The database 246 may be present either in the HIS 202 or in a similar system that stores and processes patient information, such as the scheduled procedure and duration time of the procedure.

The PWM system 300 also may contain a messaging subsystem 220. The messaging subsystem 220 may comprise a messaging engine 222 to provide an extensible, configurable framework for communicating with the internal 140 or the external 142 systems (FIG. 1). The messaging engine 222 may comprise an interface engine 224, XML streams 226, etc. Communication may be handled by one or more “transceivers” 230 that transmit messaging data 232 from the messaging engine 222 to a subsystem of the PWM system 300 and receive and provide messaging data 234 from a subsystem of the PWM system 300 to the messaging engine 222. The transceivers 230 convert outgoing internal data 232 into an external protocol specific for the purpose of each of the transceivers 230. Several transceivers 230 may be distributed throughout the messaging subsystem 220. The transceivers 230 may plug into the framework of the PWM system 300.

The PWM system 300 may comprise a multicast subsystem 240 coupled to the application server 102. The multicast subsystem 240 may comprise a multicast engine 242 to provide an extensible, configurable framework for real-time data communication among any of the communication components or elements of the internal system 140 (FIG. 1). The architecture, however, also may provide external applications to plug into the multicast subsystem 240. The architecture may be implemented as a publish/subscribe model which also enables querying. Because the multicast subsystem 240 is responsible for persisting published data, as well as querying persisted data, a portion of its architecture may lie in one or more “data adapters” 244 which plug into the multicast engine 242 in a configurable fashion to facilitate persistence and retrieval of data to the one or more databases 144 (e.g., SQL databases), etc. The data adapters 244 may be provided to operate in conjunction with the multicast subsystem 240 to provide default persistence and retrieve all data supported for communication via the multicasting engine 242. The architecture may provide for the use of custom data adapters 244 to perform custom persistence and/or retrieval functionality. The multicast subsystem 240 may be coupled to a business logic module 260 and a correction module 270 (described in more detail below). In one implementation, the business logic module 260 may comprise a component to validate the changes in the location of the patient 208.

In one embodiment, the PWM 300 comprises a correction module 270. The correction module 270 interfaces with the multicast subsystem 240. The correction module 270 receives messaging data 232 transmitted from the messaging engine 222 of the messaging subsystem 220. The messaging subsystem 220 receives the patient workflow process information or data 136 from the RTLS 206. As previously discussed, the RTLS 206 captures real-time patient location data 216 and provides that data to the PWM system 300 by way of the messaging subsystem 220. The correction module 270 processes the messaging data 232 using various techniques or processes to arrive at an accurate location of the patient 208 in the workflow process 210. For example, the correction module 270 may employ various techniques, such as adhesiveness, physical layout of the health care facility, transit times, and patient workflow process information, to arrive at an accurate location for the patient 208.

In one embodiment, the correction module 270 may employ an adhesiveness technique wherein the correction module 270 will not accept any new messaging data 232 based on patient location data 216 unless the patient 208 remains in the new location for a predetermined minimum amount of time. Therefore, when the patient 208 transitions 212 to a new location (211a→211b→211c), the new location will not be accepted in accordance with the adhesiveness technique unless the patient 208 remains at the new location (and only at the new location) long enough to break the adhesion for that transition. For example, if the patient 208 was previously located in a pre-operative area associated with the preoperative workflow process 211a and the latest RTLS 206 location data 216 places the patient 208 in an operating room associated with an intraoperative workflow process 211b for only a short period of time, or places the patient 208 elsewhere or even back where he/she started, then it is most likely a false location indication.

The time needed to determine if the patient 208 adheres may be reduced by locating multiple sensors in a desired area to detect the patient 208. For example, if the patient 208 was previously located in the preoperative area during the preoperative workflow process 211a and the last two or more RTLS 206 location data 216 readings places the patient 208 in a hallway, then this most likely indicates the true location of the patient 208. The location data 216 of the patient 208 may be stored in one or more buffers. In certain situations, the buffers may be circumvented.

The correction module 270 also may employ a transition map and transit time techniques to correct the patient location data 216 as the patient 208 transitions between different locations based on transit time. The transit time may be used as a tiebreaker when the correction module 270 receives the location data 216 from two or more areas which were not previously determined locations for the patient 208. Failure to receive any messaging data 232 by the correction module 270 may indicate that the patient 208 remained in the original location. In one embodiment, the correction module 270 may employ a best-fit model for comparing the actual time that the patient 208 reported to a new location with the transition mappings. This may be useful, for example, when the patient 208 was previously located in a preoperative area and the latest RTLS 206 location data 216 places the patient 208 in multiple operating rooms (e.g., Operating Room 1 and Operating Room 2), and the location data 216 is received from both operating rooms within a short period of time. If it takes 30 seconds to get to Operating Room 1 from the preoperative area and it takes 60 seconds to get to Operating Room 2 from the preoperative area, and the location data 216 indicates that the patient 208 was initially detected at these two new locations only 20 seconds after the previous detection in the preoperative area, then it is most likely that Operating Room 1 is the correct location of the patient 208.

The PWM 300 comprising the correction module 270 to improve the accuracy of the location data 216 received by the RFID based RTLS 206 tracking system may be deployed in a variety of health care facility environments. To accommodate various physical environments, the correction module 270 may employ the physical layout of the health care facility as well as any other information associated with the patient workflow process 210 to correct the patient location data 216 before the PWM system 300 transmits the patient information over the network 106 or 112.

In one embodiment, the RTLS 206 may be employed in location information systems related to patient care and, more particularly, to distributing messages concerning the progress of the patient 208 through the workflow process 210 (e.g., the perioperative process) to people having an association with, interest in, or relationship with the patient 208 and to the health care staff 218b. For convenience and clarity, any person having an association with, interest in, or relationship with the patient may be referred to herein as the stakeholder 218 and may comprise the patient family 218a or the staff 218b. It is to be understood, however, that the scope of the term “family” is intended to encompass more than just the traditional family members of the patient 208 and comprises friends, relatives, guardians or any person designated by the patient 208 or legal authority having an association with, interest in, or relationship with the patient 208. The embodiments, therefore, are not limited in the context of a traditional family.

The following description of the PWM system 300 functionality is with respect to the stakeholders 218 grouped under the “Patient Family” 218a category. The patient 208 is often accompanied by one or more family members 218a. These family members 218a may wait in the waiting room, move to another area of the health care facility (e.g., a cafeteria) or leave altogether. When the patient 208 arrives at the health care facility for a surgical procedure, the patient 208 is either scheduled a priori to their arrival or will be scheduled upon their arrival (e.g., emergency cases). At the time of scheduling, the information pertaining to the patient 208, the health care provider, and the procedures are persisted along with the projected start times. These reservations may be processed by the HIS 202. When the patient 208 signs into the health care facility, they receive a badge (which may comprise an RTLS tag 214) that allows them to be recognized by the RTLS 206. The RTLS 206 tracks the patients through the perioperative workflow process 210. In a broader sense, the RTLS 206 may be adapted to track the patient 208 throughout any patient workflow processes.

After the patient 208 arrives at the health care facility, the patient 208 is tracked through the workflow process 210 by both receiving movement indications in the form location data 216 from the RTLS 206 and also other staff interactions with the GUI 134 of the PWM 300. TABLE 1 provides a list of example milestones during the perioperative workflow process 210 that may be tracked by the hospital. The choice of milestones may differ across procedures and health care facilities.

TABLE 1
Patient Milestones

| | |
|---|---|
| 1. | Patient Signed in |
| 2. | Patient Ready for transport |
| 3. | Patient Sent for |
| 4. | Patient Available |
| 5. | Patient in Pre-op |
| 6. | Anesthesia interview started |
| 7. | Anesthesia interview completed |
| 8. | Anesthesia started |
| 9. | Patient in procedure room |
| 10. | Physician in room |
| 11. | Procedure begins |
| 12. | Procedure ends |
| 13. | Patient out of procedure room |
| 14. | Patient in post-anesthesia care unit (PACU) |
| 15. | Anesthesia finished |
| 16. | Patient moved to Post-op |
| 17. | Patient family interview |
| 18. | Patient ready for discharge |

The milestones listed in TABLE 1 are provided merely as an example of what the health care facility may track. These milestones may differ based on the procedures and the health care facility and, therefore, they are not exhaustive examples of milestones. Therefore, the embodiments discussed herein are not limited in this context.

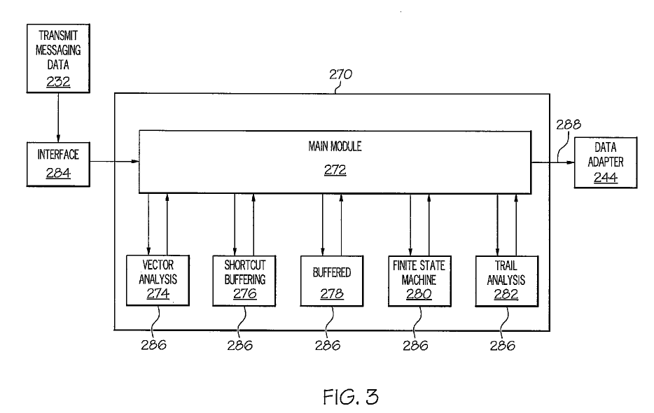

FIG. 3 is a diagram of one embodiment of the correction module 270. As previously discussed, the correction module 270 increases the accuracy of the RTLS 206 of the PWM system 300. The correction module 270 increases the accuracy of the RTLS 206 location data 216 by using information received from the workflow process 210 in conjunction with the physical layout of the health care facility. The correction module 270 removes erroneous location data 216 from the messaging data 232 that shows false movements during the patient workflow process 210 before the messaging data 232 is received by the business logic module 260 of the PWM 300. Accordingly, the business logic module 260 yields appropriate results.

As shown in FIG. 3, the correction module 270 receives the transmitted messaging data 232 via an interface 284 and outputs corrected data 288 to the data adapter 244 for processing by the business module 260. In one embodiment, the correction module 270 may comprise multiple logic modules 286 to arrive at the corrected data 288. In one embodiment, the correction module 270 may comprise a vector analysis module 274, a shortcut buffering module 276, a buffered module 278, a finite state machine 280, and a trails analysis module 282. The vector analysis module 274 interprets capable physical movements within a health care facility based on the physical layout of the facility. The buffered module 278 contains the movement history data as the patient 208 transitions between locations within the workflow process. The finite state machine 280 models the behavior of the patient 208. The model comprises a finite number of states and transitions of the patient 208 as a function of the workflow process and the adhesion technique. The trails analysis module 282 is a logical application of the buffered data associated with the movement history.

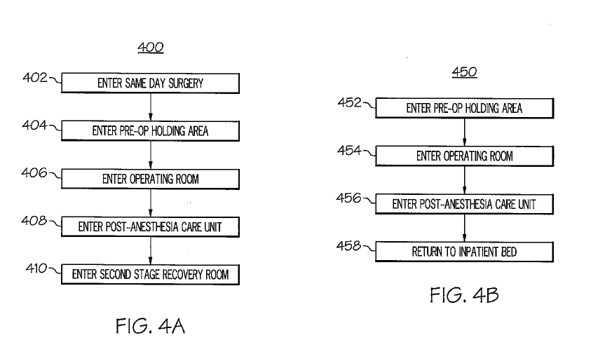

FIG. 4A is a diagram 400 illustrating the stages of one embodiment of the perioperative workflow process 210 for an ambulatory patient 208. An ambulatory 208 patient enters same-day surgery 402. The patient 208 then may enter a pre-op holding area 404. The patient 208 then enters the operating room 406, followed by a post-anesthesia care unit 408 and a second-stage recovery room 410. Optionally, the patient 208 may proceed from the operating room to an intensive care unit 412.

FIG. 4B is a diagram 450 illustrating the stages of one embodiment of the perioperative workflow process 210 for an inpatient 208. An inpatient 208 may enter a pre-op holding area 452. The patient 208 then enters the operating room 454, followed by a post-anesthesia care unit 456. Following the post-anesthesia care unit, the patient 208 returns to an inpatient bed 458.

In various embodiments, the patient workflow process system 100 and/or the perioperative system 200 may be illustrated and described as comprising several separate functional elements, such as modules. Although certain modules may be described by way of example, it can be appreciated that more or fewer modules may be used and still fall within the scope of the embodiments. Further, although various embodiments may be described in terms of modules to facilitate description, such modules may be implemented by one or more hardware components (e.g., processors, DSPs, PLDs, ASICs, circuits, registers), software components (e.g., programs, subroutines, logic, application components), and/or combinations thereof.

The modules may comprise, or may be implemented as, one or more systems, sub-systems, devices, components, circuits, logic, programs, or any combinations thereof, as desired for a given set of design or performance constraints. For example, the modules may comprise electronic elements fabricated on a substrate. In various implementations, the electronic elements may be fabricated using silicon-based integrated circuit processes, such as, for example, complementary metal oxide semiconductor (CMOS), bipolar, and bipolar CMOS (BiCMOS) processes. The embodiments are not limited in this context.

Numerous specific details of the RTLS 206 and correction module 270 therefor have been set forth herein to provide a thorough understanding of the embodiments. It will be understood by those skilled in the art, however, that the embodiments may be practiced without these specific details. In other instances, well-known operations, components, and circuits have not been described in detail so as not to obscure the embodiments. It can be appreciated that the specific structural and functional details disclosed herein may be representative and do not necessarily limit the scope of the embodiments.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some embodiments may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a general-purpose or special-purpose processor. In another example, an embodiment may be implemented as dedicated hardware, such as a circuit, an application-specific integrated circuit (ASIC), Programmable Logic Device (PLD) or digital signal processor (DSP), and so forth. In yet another example, an embodiment may be implemented by any combination of programmed general-purpose computer components and custom hardware components. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, also may mean that two or more elements are not in direct contact with each other, but yet still co-operate or interact with each other. The embodiments are not limited in this context.

Some embodiments may be implemented, for example, using a machine-readable medium or article which may store an instruction or a set of instructions that, if executed by a machine, may cause the machine to perform a method and/or operation in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory module. For example, the memory module may include any memory device, memory article, memory medium, storage device, storage article, storage medium and/or storage module, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, various types of Digital Versatile Disk (DVD), a tape, a cassette, or the like. The instructions may include any suitable type of code, such as source code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, assembly language, machine code, and so forth. The embodiments are not limited in this context.

While certain features of the embodiments have been illustrated as described herein, many modifications, substitutions, changes and equivalents will now occur to those skilled in the art. It is therefore to be understood that the appended claims are intended to cover all such modifications and variations, as well as any other applicable technologies which may appear in the future, as falling within the true scope of the embodiments.

What is claimed is:

1. A method, comprising:
receiving data indicating one or more locations of a patient within a health care facility; and
applying a correction to at least a portion of the received data to determine a location of the patient relative to a perioperative workflow process.

2. The method of claim 1, wherein receiving data comprises:
receiving the data substantially in real-time.

3. The method of claim 1, comprising:
storing a first location of the patient indicated by the received data;
storing a second location of the patient indicated by the received data, wherein the second location is subsequent in time to the first location;
monitoring an amount of time spent by the patient at the second location; and
determining the patient's location to be one of the first location and the second location based on the monitored amount of time.

4. The method of claim 3, comprising:
determining the first location to be the patient's location when the monitored amount of time is less than a predetermined minimum amount of time.

5. The method of claim 3, comprising:
determining the second location to be the patient's location when the monitored amount of time greater than or equal to a predetermined minimum amount of time.

6. The method of claim 1, comprising:
defining a transition map, wherein defining a transition map comprises:
identifying a number of predetermined locations within the health care facility; and
associating an expected transit time with each unique pair of locations within the number of predetermined locations;

7. The method of claim 6, comprising:
measuring a transit time of the patient between a first location and a group of second locations indicated by the received data;
determining the expected transit time between the first location and each second location based on the transition map;
comparing the measured transit time to each expected transit time; and
determining the patient's location to be one of the second locations based on the comparisons.

8. The method of claim 7, wherein determining the patient's location comprises determining the patient's location in accordance with a best fit model.

9. The method of claim 1, comprising:
communicating the determined location to at least one stakeholder.

10. The method of claim 9, comprising:
communicating the determined location in accordance with a preference defined by the at least one stakeholder.

11. A patient workflow management system, comprising:
a messaging subsystem to receive data indicating one or more locations of a patient within a health care facility; and
a correction module in communication with the messaging subsystem to apply a correction to at least a portion of the received data to determine a location of the patient relative to a perioperative workflow process.

12. The system of claim 11, wherein the messaging subsystem is configured to receive the data substantially in real-time.

13. The system of claim 11, wherein the correction module is configured to:
store a first location of the patient indicated by the received data;
store a second location of the patient indicated by the received data, wherein the second location is subsequent in time to the first location;
monitor an amount of time spent by the patient at the second location; and
determine the patient's location to be one of the first location and the second location based on the monitored amount of time.

14. The system of claim 13, wherein the correction module is configured to:
determine the first location to be the patient's location when the monitored amount of time is less than a predetermined minimum amount of time.

15. The system of claim 13, wherein the correction module is configured to:
determine the second location to be the patient's location when the monitored amount of time greater than or equal to a predetermined minimum amount of time.

16. The system of claim 11, wherein the correction module is configured to define a transition map, the transition map comprising:
a number of predetermined locations with the health care facility; and
an expected transit time associated with each unique pair of locations within the number of predetermined locations.

17. The system of claim 16, wherein the correction module is configured to:
measure a transit time of the patient between a first location and a group of second locations indicated by the received data;
determine the expected transit time between the first location and each second location based on the transition map;
compare the measured transit time to each expected transit time; and
determine the patient's location to be one of the second locations based on the comparisons.

18. The system of claim 17, wherein the correction module is configured to:
determine the patient's location in accordance with a best fit model

19. The system of claim 11, comprising:
a multicasting engine to communicate the determined location to at least one stakeholder

20. The system of 19, wherein the multicasting engine is configured to communicate the determined location in accordance with a preference defined by the at least one stakeholder.
